(19) United States
(12) Patent Application Publication
(10) Pub. No.: US 2017/0280393 A1
(43) Pub. Date: Sep. 28, 2017

(54) METHOD AND MOBILE DEVICE FOR CONTROLLING

(71) Applicants: Le Holdings (Beijing) Co., Ltd., Beijing (CN); Lemobile Information Technology (Beijing) Co., Ltd., Beijing (CN)

(72) Inventor: Haosen SUO, Beijing (CN)

(21) Appl. No.: 15/264,339

(22) Filed: Sep. 13, 2016

Related U.S. Application Data
(63) Continuation-in-part of application No. PCT/CN2016/096262, filed on Aug. 22, 2016.

(30) Foreign Application Priority Data
Mar. 25, 2016 (CN) 2016101801025

(51) Int. Cl. H04W 52/02

(52) U.S. Cl. CPC H04W 52/0254; H04W 52/027

(57) ABSTRACT

Disclosed are a method and electronic device for controlling. According to the method for controlling provided by the embodiments of the present disclosure, by detecting pressure information of a force touch area of a side frame of a mobile device when preset condition is met, controlling the screen status of the mobile device according to the detected pressure information, and intelligently adjusts the screen status of the mobile device by virtue of the practical use condition of a user about the mobile device reflected by the pressure information, the power consumption of the mobile device is reduced, the user experience is enhanced, and the user satisfaction is improved. Therefore, the technical solution provided by the embodiments of the present disclosure can solve the problem of the prior art that the screen status of a mobile device cannot be intelligently adjusted according to the practical use condition of a user.

### CROSS REFERENCE TO RELATED APPLICATIONS

This application is a continuation-in-part of International Application No. PCT/CN2016/096262, filed on Aug. 22, 2016, which is based upon and claims priority to Chinese Patent Application No. 2016101801025, filed on Mar. 25, 2016, the entire contents of which are incorporated herein by reference.

### TECHNICAL FIELD

The present disclosure relates to the field of communication, and more particularly, to a method and mobile device for controlling

### BACKGROUND

At present, many mobile devices have screen lock and screen off functions. Where, screen lock means to turn off a screen of a mobile device, so that the mobile device cannot be used when it is not unlocked, and can only be used after unlocking using the password, graph or fingerprint, etc. set by its user. Screen off means to turn off the screen of a mobile device, so that the screen of the mobile device enters a black screen status.

In the prior art, a user can turn on or off the functions, such as automatic screen lock and screen off by using the functions, e.g. setting, of a mobile device, and can further select or set the duration of automatic screen lock and screen off. Taking a mobile phone as an example, if a user sets the duration of automatic screen lock of the mobile device to be 30 seconds, and if the user does not have any operation on the mobile device in 30 seconds, the mobile device will automatically turn off the screen. The principle of screen off is similar to that of screen lock.

In some application scenarios, users need to turn off the functions of automatic screen lock and screen off. In these scenarios, if a user does not use a mobile device, the power of the mobile device will be wasted. In some other scenarios, even if the functions of both automatic screen lock and screen off are turned on, the mobile device will not enter a screen lock or screen off status. For example, if a smart phone is used to play videos (e.g., watch a movie) for a long time, the user may have fallen asleep, but the video has been in a playing status, so the condition of automatic screen lock and screen off will not be met, and the phone will not automatically lock the screen or turn off the screen under the circumstance. Under such circumstance, the power of the mobile device will also be consumed meaninglessly.

In the process of implementing the present disclosure, the inventor found that the prior art at least has the following problems.

The screen status of a mobile device cannot be intelligently adjusted according to the practical use condition of a user.

### SUMMARY

In view of this, the present disclosure provides a method and mobile device for controlling to solve the problem of the prior art that the screen status of a mobile device cannot be intelligently adjusted according to the practical use condition of a user.

On the one hand, the embodiments of the present disclosure provide a method for controlling applied in a mobile device, including: detecting pressure information of a force touch area of a side frame of a mobile device when preset condition is met; and controlling the screen status of the mobile device according to the detected pressure information.

According to the abovementioned aspect and any possible implementation way, an implementation way is further provided. The control over the screen status of the mobile device according to the detected pressure information includes: controlling the screen of the mobile device to enter a screen lock and/or screen off status when the pressure value of the force touch area of the side frame of the mobile device is all zero.

According to the abovementioned aspect and any possible implementation way, an implementation way is further provided. The control over the screen status of the mobile device according to the detected pressure information includes: reducing the brightness of the screen of the mobile device when the pressure value of the force touch area of the side frame of the mobile device is decreased.

According to the abovementioned aspect and any possible implementation way, an implementation way is further provided. The control over the screen status of the mobile device according to the detected pressure information includes: maintaining the brightness of the screen of the mobile device unchanged when the pressure value of the force touch area of the side frame of the mobile device remains unchanged or is increased.

According to the abovementioned aspect and any possible implementation way, an implementation way is further provided. The preset condition is that the current time is in a preset period of time.

According to the abovementioned aspect and any possible implementation way, an implementation way is further provided. The preset condition is that the mobile device is powered on.

One of the above technical solutions has the following beneficial effects: the method for controlling according to the embodiment of the present disclosure can reflect practical use condition of a user about a mobile device according to pressure information, and intelligently adjust the screen status of the mobile device, thereby reducing power consumption of the mobile device, enhancing the user experience, and improving the user satisfaction degree.

On the other hand, the embodiments of the present disclosure provide a mobile device, including: a processor, and a memory for storing the processor-executable instructions, where, the processor is configured for detecting the pressure information of the force touch area of the side frame of the mobile device when preset condition is met, and controlling the screen status of the mobile device according to the detected pressure information.

On the other hand, the embodiments of the present disclosure provide a non-transient computer-readable storage medium storing computer-executable instructions for detecting pressure information of a force touch area of a side frame of a mobile device when preset condition is met, and controlling the screen status of the mobile device according to the detected pressure information.

One of the above technical solutions has the following beneficial effects: the mobile device according to the embodiments of the present disclosure can execute the preceding method for controlling, reflect practical use condition of a user about the mobile device according to pressure information, and intelligently adjust the screen status of the mobile device, thereby reducing power consumption of the mobile device, enhancing the user experience, and improving the user satisfaction degree.

### BRIEF DESCRIPTION OF THE DRAWINGS

One or more embodiments are illustrated by way of example, and not by limitation, in the figures of the accompanying drawings, where elements having the same reference numeral designations represent like elements. The drawings are not to scale, unless otherwise disclosed.

FIG. 1 is a flow chart of the method for controlling in accordance with some embodiments of the present disclosure;

FIG. 2 is a schematic diagram of a side frame of a mobile phone in some embodiments of the present disclosure;

FIG. 3 is a flow chart of the method for controlling in accordance with some embodiments of the present disclosure;

FIG. 4 is a flow chart of the method for controlling in accordance with some embodiments of the present disclosure;

FIG. 5 is a block diagram of functions of the control device provided by some embodiments of the present disclosure; and

FIG. 6 is a schematic diagram of a structure of the mobile device provided by some embodiments of the present disclosure.

### DETAILED DESCRIPTION

The preferred embodiments of the present disclosure are illustrated with reference to the appended drawings below, and it will be appreciated that the preferred embodiments described herein are only presented to illustrate and explain the present disclosure, and are not intended to limit the present disclosure.

It shall be clear that only parts of the embodiments, instead of all embodiments, of the present disclosure are presented. Based on the embodiments of the present disclosure, all other embodiments concluded by those skilled in the art without making inventive labor fall within the scope of protection of the present disclosure.

As used in the embodiments of the present disclosure, the terms are intended to describe specific embodiments only, and are not intended to limit the present disclosure. The singular forms of “a”, “the” and “this” used in the embodiments and appended claims of the present disclosure are also intended to include plural forms, unless the context clearly indicates other meanings.

It will be appreciated that the term “and/or” is used herein just to describe the relationship of associated objects, and means to include three relationships. For example, A and/or B means that A exists alone, or both A and B exist, or B exists alone. In addition, the character “/” herein generally means that there is a relationship of “or” between front and rear associated objects.

It will be appreciated that the embodiments of the present disclosure may use the terms first, second, third and the like to describe XXX, but these XXX should not be limited to these terms. These terms are used to distinguish the XXX from one another only. For example, first XXX can also be called second XXX, and similarly, second XXX can also be called first XXX without departing from the scope of the embodiments of the present disclosure.

Depending on the context, as used herein, the word “if” can be interpreted as “at the time of . . . ” or “when . . . ” or “in response to determination” or “in response to detection”. Similarly, depending on the context, the phrase “if it is determined” or “if it is detected (stated conditions or events)” may be interpreted as “when determining” or “in response to determination” or “when detecting (stated conditions or events)” or “in response to detection (stated conditions or events).”

### Embodiment 1

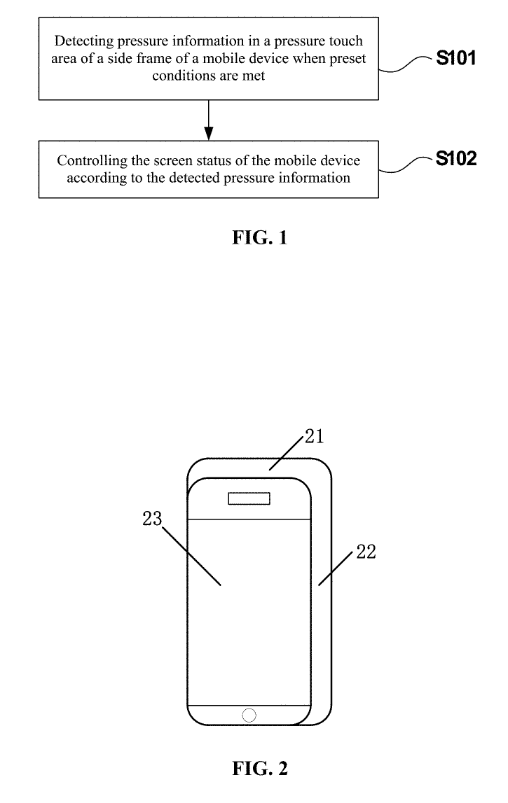

The embodiments of the present disclosure provide a method for controlling applied to a mobile device. Please refer to FIG. 1, which is a flow chart of the method for controlling in accordance with some embodiments of the present disclosure. As shown in FIG. 1, the method may include the following steps S101-S102.

S101: a pressure information of a force touch area of a side frame of a mobile device is detected when a preset condition is met.

The preset condition can be regarded as the condition to start detection. The mobile device will start detecting the pressure information of the force touch area of the side frame only when the preset condition is met. The mobile device will not start detecting the pressure information of the force touch area of the side frame when the preset condition is not met. Therefore, the preset condition allows users to flexibly control whether to start detection or not according to the needs of specific application scenarios.

Where, the preset condition may be that the current time is in a preset period of time. For example, a user may set the preset condition as that “the current time is in a period of time from 22:00 to 02:00”, so as to use the function of the method for controlling according to the present disclosure in a period of time (e.g. 22:00-02:00) at night. In this way, in other periods of time, this function can be turned off to reduce power consumption of the mobile device. The preset condition is set as that “current time is in a preset period of time”, which is considered to be mainly based on user habits, because people usually tend to fall asleep when they are using mobile devices late at the night. Under the circumstance, if screens of the mobile devices are not locked or turned off, a lot of power will be wasted.

Where, the preset condition may also be that the mobile device is powered on. That is to say, as long as a mobile device is powered on, it will start detecting the pressure information of the force touch area of the side frame.

Of course, the preset condition includes, but is not limited to, the examples listed above.

It should be noted that, the mobile device involved in various embodiments of the present disclosure may include, but is not limited to, a personal computer (PC), a personal digital assistant (PDA), a wireless handheld device, a notebook computer, a tablet computer, a mobile phone, an MP3 player, an MP4 player, etc.

By a force touch technology, a mobile device can sense pressure level of a force touch area. The pressure level can usually be expressed as a pressure value.

According to some embodiments of the present disclosure, the force touch area can be located on a side frame of a mobile device. A mobile phone is taken as an example. FIG. 2 is a schematic diagram of the side frame of the mobile phone in the embodiment of the present disclosure. As shown in FIG. 2, the side frame of the mobile phone includes an upper frame 21, a lower frame (not shown in the figure), a left frame (not shown in the figure) and a right frame 22. The screen 23 of the mobile phone is located on the front face of the mobile phone. Herein, each side frame (e.g., the upper frame, the lower frame, etc.) is named based on the vertical placement status of the mobile device.

Where, the pressure information may include a specific pressure value, pressure changes (increased, decreased and unchanged), pressure positions, and so on.

The pressure information of the force touch area of the side frame of the mobile device reflects practical use condition of a user about the mobile device. For example, if a user has been holding and using a mobile device, then the force touch area of the side frame of the mobile device will sense continuous pressure. After the user falls asleep, even if the mobile device is still held by the user in hand, but the force touch area of the side frame of the mobile device senses no pressure, or it can be said that the pressure value sensed in the force touch area of the side frame of the mobile device is already zero.

S102: the screen status of the mobile device is controlled according to the detected pressure information.

As previously mentioned, the pressure information reflects the practical use condition of a user about a mobile device, so that the mobile device can intelligently control the screen status of the mobile device based on practical use condition of a user about the mobile device, such as locking the screen, turning off the screen, controlling the screen brightness, and so on.

It should be noted that, the executive object of the above steps S101-S102 may be a device which may be an App in a local device or a function unit, such as a plug-in or a software development kit (SDK) in the App in the local device, which is not particularly limited by any embodiments of the present disclosure.

It will be appreciated that, the application may be a native App installed in a device, or may also be a web App on a browser in the device, which is not limited by the embodiments of the present disclosure.

The method for controlling according to the embodiment of the present disclosure can reflect practical use condition of a user about a mobile device according to the pressure information, and intelligently adjust the screen status of the mobile device, thereby reducing power consumption of the mobile device, enhancing the user experience, and improving the user satisfaction degree.

### Embodiment 2

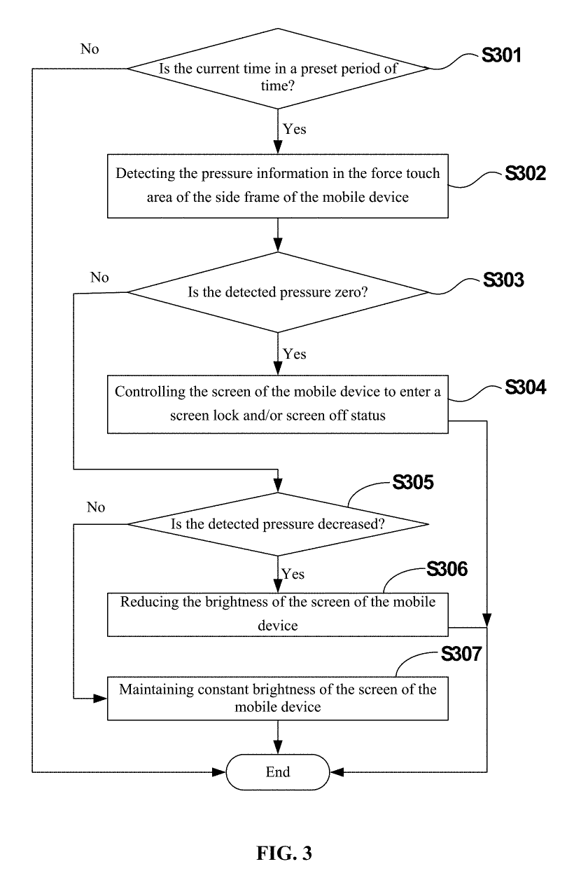

FIG. 3 is a flow chart of the method for controlling in accordance with some embodiments of the present disclosure. As shown in FIG. 3, according to the embodiment, the method for controlling may include steps S301-S307 as follows.

S301: whether the current time is in a preset period of time is determined, and step S302 is executed if the current time is in a preset period of time, or the method is finished if the current time is not in a preset period of time.

In this embodiment, detection is started under the condition that the current time is in a preset period of time.

S302: a pressure value of a force touch area of a side frame of a mobile device is detected.

S303: whether the detected pressure value is 0 is determined: step S304 is executed if the detected pressure value is 0, or step S305 is executed if the detected pressure value is not 0.

S304: the screen of the mobile device is controlled to enter a screen lock and/or screen off status, and the method is ended.

This step realizes a smart sleep of the mobile device.

S305: whether the detected pressure value is decreased or not is determined. Step S306 is executed if the detected pressure value is decreased, or step S307 is executed if the pressure value is not decreased.

S306: the brightness of the screen of the mobile device is reduced, and the method is ended.

When the pressure value of the force touch area of the side frame of the mobile device is decreased, a user is likely to be falling asleep. Under the circumstance, the brightness of the screen of the mobile device is immediately adjusted according to the pressure change, thereby minimizing power consumption of the mobile device.

S307: the brightness of the screen of the mobile device is maintained unchanged, and the method is ended.

The method for controlling according to the embodiment of the present disclosure can reflect practical use condition of a user about a mobile device according to pressure information, and intelligently adjust the screen status of the mobile device, thereby reducing power consumption of the mobile device, enhancing the user experience, and improving the user satisfaction degree.

### Embodiment 3

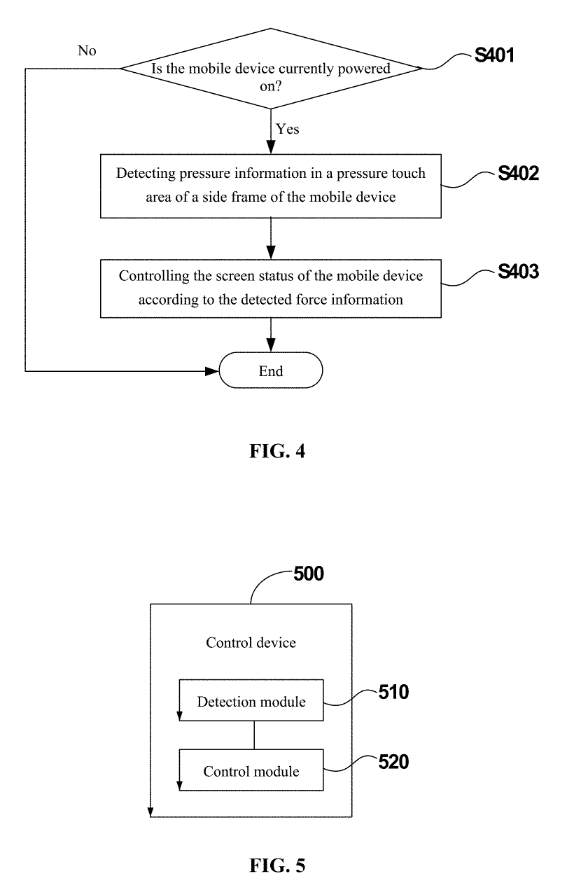

FIG. 4 is a flow chart of the method for controlling in accordance with some embodiments of the present disclosure. As shown in FIG. 4, according to the embodiment, the method for controlling may include steps S401-S403 as follows.

S401: whether a mobile device is currently powered on or not is determined: step S402 is executed if the mobile device is currently powered on, or the method is ended if the mobile device is currently powered off.

According to this embodiment, detection is started under the condition that a mobile device is powered on.

S402: a pressure information of a force touch area of a side frame of a mobile device is detected.

S403: the screen status of the mobile device is controlled according to the detected pressure information.

The method for controlling according to the embodiment of the present disclosure can reflect practical use condition of a user about a mobile device according to pressure information, and intelligently adjust the screen status of the mobile device, thereby reducing power consumption of the mobile device, enhancing the user experience, and improving the user satisfaction degree.

The embodiment of the present disclosure further provides an embodiment of a device for implementing various steps and methods according to the above embodiments of the methods.

Please refer to FIG. 5, which is a block diagram of functions of the control device provided by the embodiment of the present disclosure. As shown in FIG. 5, according to the present embodiment, the control device 500 may include a detection module 510 and a control module 520.

Where, the detection module 510 is used for detecting the pressure information of the force touch area of the side frame of the mobile device when preset condition is met. The control module 520 is used for controlling the screen status of the mobile device according to the pressure information detected by the detection module 510.

Where, the preset condition may be that the current time is in a preset period of time.

Where, the preset condition may also be that the mobile device is powered on.

According to the embodiment of the present disclosure, the control module 520 may include a screen lock unit. The screen lock unit is used for controlling the screen of the mobile device to enter a screen lock and/or screen off status when the pressure value of a force touch area of a side frame of the mobile device is all zero.

According to the embodiment of the present disclosure, the control module 520 may include a brightness control unit, which is used for reducing the brightness of the screen of a mobile device when the pressure value of a force touch area of a side frame of the mobile device is decreased.

According to the embodiment of the present disclosure, the control module 520 may include a maintaining unit, which is used for maintaining the brightness of the screen of a mobile device unchanged when the pressure value of a force touch area of a side frame of the mobile device remains unchanged or is increased.

The control device according to the present embodiment is capable of executing the method for controlling according to preceding embodiments of the present disclosure. Please refer to relevant description of the preceding embodiments of the method for controlling of the present disclosure for more details of the present embodiment.

The control device according to the embodiment of the present disclosure can reflect practical use condition of a user about a mobile device according to pressure information, and intelligently adjust the screen status of the mobile device, thereby reducing power consumption of the mobile device, enhancing the user experience, and improving the user satisfaction degree.

The embodiment of the present invention further provides a mobile device including a processor and a memory. Where, the memory is used for storing processor-executable instructions. The processor is configured for detecting pressure information of a force touch area of a side frame of the mobile device when preset condition is met, and controlling the screen status of the mobile device according to the detected pressure information.

Where, the mobile device may be a mobile phone, a tablet PC, and the like.

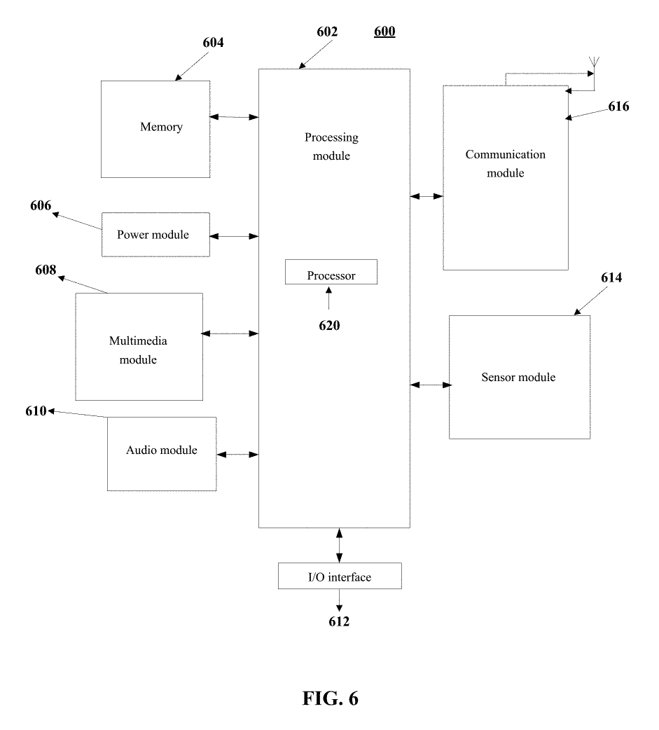

Please refer to FIG. 6, which is a schematic diagram of a structure of the mobile device provided by the embodiment of the present disclosure. As shown in FIG. 6, the mobile device 600 may include one or more of the following modules: a processing module 602, a memory 604, a power module 606, a multimedia module 608, an audio module 610, an input/output (I/O) interface 612, a sensor module 614, and a communication module 616.

The processing module 602 usually controls the overall operation of the mobile device 600, such as the operations associated with display, phone calls, data communication, camera operation and recording. The processing module 602 may include one or more processors 620 to execute instructions and complete all or part of steps of the above control methods, specifically including: detecting the pressure information of the force touch area of the side frame of the mobile device when preset condition is met; and controlling the screen status of the mobile device according to the detected pressure information. Moreover, the processing module 602 may include one or more modules to facilitate interaction between the processing module 602 and other modules. For example, the processing module 602 may include a multimedia module to facilitate interaction between the multimedia module 608 and the processing module 602.

The memory 604 is configured to store various types of data to support operations on the mobile device 600. Examples of such data include instructions of any application or method for operations on the mobile device 600, contact data, phonebook data, message, picture, video, and the like. The memory 604 may be implemented by any type of volatile or non-volatile storage devices, or combinations thereof, such as a static random access memory (SRAM), an electrically erasable programmable read-only memory (EEPROM), an erasable programmable read only memory (EPROM), a programmable read-only memory (PROM), a read-only memory (ROM), a magnetic memory, a flash memory, a magnetic disk or an optical disk.

The power module 606 provides power for various modules of the mobile device 600. The power module 606 may include a power management system, one or more power sources, and other modules associated with generation, management and distribution of power for the mobile device 600.

The multimedia module 608 includes a screen providing an output interface between the mobile device 600 and a user. According to some embodiments, a screen may include a liquid crystal display (LCD) and a touch panel (TP). If a screen includes a touch panel, the screen may be implemented by a touch screen to receive input signals from users. The touch panel includes one or more touch sensors to sense touch, sliding and gestures on the touch panel. The touch sensor can not only sense the boundary of a touch or sliding operation, but also detect the duration and pressure associated with the touch the sliding operation. According to some embodiments, the multimedia module 608 includes a front camera and/or a rear camera. When the mobile device 600 is in an operating mode, such as a shooting mode or a video mode, the front camera and/or the rear camera can receive outside multimedia data. Each front camera and rear camera may be a fixed optical lens system or with a focus and optical zoom capacity.

The audio module 610 is configured to output and/or input audio signals. For example, the audio module 610 includes a microphone (MIC). When the mobile device 600 is in an operating mode, such as a calling mode, a recording mode and a voice recognition mode, the microphone is configured to receive outside audio signals. The received audio signals may be further stored in the memory 604 or transmitted via the communication module 616. According to some embodiments, the audio module 610 further includes a speaker for outputting audio signals.

The I/O interface 612 provides an interface between the processing module 602 and peripheral interface modules. The peripheral interface module may be a keyboard, a click wheel, a button, and the like. These buttons may include, but are not limited to: a home page button, a volume button, a start button and a lock button.

The sensor module 614 includes one or more sensors for providing status evaluation of the mobile device 600 in various aspects. For example, the sensor module 614 can detect the on/off status of the mobile device 600, and relative positioning of modules. For example, the module is a display device and a keypad of the mobile device 600. The sensor module 614 may also detect position change of the mobile device 600 or a module of the mobile device 600, existence or non-existence of the contact of a user with the mobile device 600, orientation or acceleration/deceleration of the mobile device 600, and temperature change of the mobile device 600. The sensor module 614 may include a proximity sensor configured to detect the existence of nearby objects without any physical contact. The sensor module 614 may further include a light sensor, e.g. CMOS or CCD image sensor, for use in imaging application. According to some embodiments, the sensor module 614 may further include an acceleration sensor, a gyro sensor, a magnetic sensor, a pressure sensor or a temperature sensor.

The communication module 616 is configured to facilitate wire or wireless communication between the mobile device 600 and other devices. The mobile device 600 can be connected to wireless network based on the communication standard, such as WiFi, 2G, 3G, or 4G or combinations thereof. According to one exemplary embodiment, the communication module 616 receives broadcast signals or broadcast associated information from an outside broadcast management system via a broadcast channel. According to one exemplary embodiment, the communication module 616 further includes a near field communication (NFC) module to facilitate short-range communication. For example, the NFC module may be implemented based on a radio frequency identification (RFID) technology, an infrared data association (IrDA) technology, ultra wideband (UWB) technology, a Bluetooth (BT) technology and other technologies.

According to an exemplary embodiment, the mobile device 600 may be implemented by one or more application specific integrated circuits (ASIC), digital signal processors (DSP), digital signal processing devices (DSPD), programmable logic devices (PLD), field programmable gate arrays (FPGA), controllers, microcontrollers, microprocessors or other electronic components, for executing the above methods.

The mobile device according to the embodiment of the present disclosure can execute the preceding method for controlling, reflect practical use condition of a user about the mobile device according to pressure information, and intelligently adjust the screen status of the mobile device, thereby reducing power consumption of the mobile device, enhancing the user experience, and improving the user satisfaction degree.

Those skilled in the art can clearly understand that, for convenience and simplicity of description, the corresponding processes in the preceding embodiments of the methods may be referred to for specific working process of the preceding system, device and modules, which are not repeated any more here.

According to a few embodiments of the present disclosure, it will be appreciated that the disclosed system, device and method may be implemented by other means. For example, the embodiments of the preceding device are merely illustrative. For example, the modules are divided only by logical functions, and may be divided based on additional considerations in actual implementation. For example, a plurality of modules or components may be combined or integrated into another system, or some features may be ignored or not executed. Besides, the revealed or discussed mutual coupling or direct coupling or communication connection may be indirect coupling or communication connection through some interface, devices, or modules, and may be electrical, mechanical, or in other forms.

The modules described as separate components may be or may also not be physically separated, and the components shown as a unit may be or may also not be a physical unit, i.e., may be located in one place, or may also be distributed to a plurality of network units. According to actual needs, part or all of the modules therein are selected to achieve the object of the solution of present embodiment.

In addition, various functional modules according to various embodiments of the present disclosure may be integrated in a processing unit, or each module may also separately and physically exist, or two or more modules are integrated in one unit. The above integrated unit may be implemented in the form of hardware, and may also be implemented in the form of hardware and software function units.

The embodiments of the present application provide a non-volatile (non-transient) computer storage medium storing computer-executable instructions that can execute the method in the embodiments of any of the above methods.

The above integrated unit implemented in the form of software function units may be stored in a computer readable storage medium. The above software function unit is stored in a storage medium, including a plurality of instructions for enabling a computer device (which may be a personal computer, a server, or a network device, etc.) or a processor to execute some steps of the method according to various embodiments of the present disclosure. The preceding storage medium includes: various media that can store program codes, such as a U disk, a mobile HDD, a read-only memory (ROM), a random access memory (RAM), a magnetic disk, or an optical disk.

The above product can execute the method provided by the embodiments of the present application, and has corresponding function modules for executing the method and beneficial effects. For more technical details of the embodiment, please refer to the method provided by the embodiments of the present application.

The mobile device according to the embodiment of the present application exists in a variety of forms, including but not limited to the following devices:

Mobile communication devices: the characteristics of such devices are that they have mobile communication functions, and mainly aim to provide voice and data communication. Such terminals include: smart phones (such as iPhone), multimedia mobile phones, functional mobile phones, low-end mobile phones, etc.

Ultra-mobile PC devices: such devices belong to the category of PC, have calculating and processing functions, and usually also have mobile Internet features. Such terminals include: PDA, MID, UMPC devices, etc., e.g. iPad.

Portable entertainment devices: such devices can display and play multimedia contents. Such devices include: audio, video players (such as iPad), handheld game players, e-books, smart toys and portable vehicle navigation devices.

Servers: devices providing computing service. The server components include a processor, hard drives, an internal memory, a system bus, etc. Structures of the servers are similar to that of a general computer. But because of the need of providing highly reliable service, the requirements in respect of processing capacity, stability, reliability, security, scalability, manageability, etc. are very high.

Other electronic devices having data interaction functions.

The embodiments of the devices described above are presented by way of example only, where the units described as separate components may be or may also not be physically separated, and the components shown as a unit may be or may also not be a physical unit, i.e., may be located in one place, or may also be distributed to a plurality of network units. According to actual needs, part or all of the modules therein are selected to achieve the object of the solution of this embodiment.

Through the description of the above embodiments, those skilled in this art can clearly understand that various embodiments may be implemented using software and a universal hardware platform, and of course, may also be implemented by hardware. Based on such understanding, the above technical solution may be essentially reflected or the parts thereof making contribution to related technology may be reflected in the form of software products. The computer software products may be stored in the computer readable storage medium, e.g. an ROM/RAM, a disk, a CD, and the like, including a number of instructions for causing a computer device (a PC, a server, or a network device, etc.) to execute the methods according to various embodiments or some parts of the embodiments.

Finally, it should be noted that: the above embodiments are only presented to show the technical solutions of this application, rather than limiting them. This application is described in detail with reference to the preceding embodiments, but those skilled in the art shall understand that: they can still modify the technical solutions according to various preceding embodiments, or equivalently replace part of the technical features thereof; and these modifications or replacements do not cause the essence of corresponding technical solutions to depart from the spirit and scope of the technical solutions according to various embodiments of this application.

What is claimed is:

1. A method for controlling, applied to a mobile device, the said method comprising:
detecting pressure information of a force touch area of a side frame of the mobile device when preset condition is met; and
controlling the screen status of the mobile device according to the detected pressure information.

2. The method for controlling according to claim 1, wherein the controlling the screen status of the mobile device according to the detected pressure information comprises:
controlling the screen of the mobile device to enter a screen lock and/or screen off status when the pressure value of the force touch area of the side frame of the mobile device is all zero.

3. The method for controlling according to claim 1, wherein the controlling the screen status of the mobile device according to the detected pressure information comprises:
reducing the brightness of the screen of the mobile device when the pressure value of the force touch area of the side frame of the mobile device is decreased.

4. The method for controlling according to claim 1, wherein the controlling the screen status of the mobile device according to the detected pressure information comprises:
maintaining the brightness of the screen of the mobile device unchanged when the pressure value of the force touch area of the side frame of the mobile device remains unchanged or is increased.

5. The method for controlling according to claim 1, wherein, the preset condition is that the current time is in a preset period of time.

6. The method for controlling according to claim 1, wherein, the preset condition is that the mobile device is powered on.

7. A mobile device, comprising:
a processor; and
a memory, for storing the processor-executable instructions,
wherein the processor is configured for:
detecting pressure information of a force touch area of a side frame of the mobile device when preset condition is met; and
controlling the screen status of the mobile device according to the detected pressure information.

8. The mobile device according to claim 7, wherein, the mobile device is a mobile phone or a tablet PC.

9. The mobile device according to claim 7, wherein, the processor is configured for:
controlling the screen of the mobile device to enter screen lock and/or screen off status when the pressure value of the force touch area of the side frame of the mobile device is all zero.

10. The mobile device according to claim 7, wherein, the processor is configured for:
reducing the brightness of the screen of the mobile device when the pressure value of the force touch area of the side frame of the mobile device is decreased.

11. The mobile device according to claim 7, wherein, the processor is configured for:
maintaining the brightness of the screen of the mobile device unchanged when the pressure value of the force touch area of the side frame of the mobile device remains unchanged or is increased.

12. The mobile device according to claim 7, wherein, the preset condition is that the current time is in a preset period of time.

13. The mobile device according to claim 7, wherein, the preset condition is that the mobile device is powered on.

14. A non-transient computer-readable storage medium, wherein storing computer-executable instructions for:
detecting pressure information of a force touch area of a side frame of a mobile device when preset condition is met; and
controlling the screen status of the mobile device according to the detected pressure information.

15. The non-transient computer-readable storage medium according to claim 14, wherein, the computer-executable instructions are used for:
controlling the screen of the mobile device to enter screen lock and/or screen off status when the pressure value of the force touch area of the side frame of the mobile device is all zero.

16. The non-transient computer-readable storage medium according to claim 14, wherein, the computer-executable instructions are used for:
reducing the brightness of the screen of the mobile device when the pressure value of the force touch area of the side frame of the mobile device is decreased.

17. The non-transient computer-readable storage medium according to claim 14, wherein, the computer-executable instructions are used for:
maintaining the brightness of the screen of the mobile device unchanged when the pressure value of the force touch area of the side frame of the mobile device remains unchanged or is increased.

18. The non-transient computer-readable storage medium according to claim 14, wherein, the preset condition is that the current time is in a preset period of time.

19. The non-transient computer-readable storage medium according to claim 14, wherein, the preset condition is that the mobile device is powered on.
